(19) United States
(12) Patent Application Publication
(10) Pub. No.: US 2013/0046655 A1
(43) Pub. Date: Feb. 21, 2013

(54) METHODS AND SYSTEMS FOR DYNAMICALLY SELECTING A PAYMENT PROCESSING GATEWAY

(71) Applicants: Sunil Karkera, San Jose, CA (US); Preston Stuteville, Mountain View, CA (US)

(72) Inventors: Sunil Karkera, San Jose, CA (US); Preston Stuteville, Mountain View, CA (US)

(73) Assignee: REGISTRIA, INC., Palo Alto, CA (US)

(21) Appl. No.: 13/210,972

(22) Filed: Aug. 16, 2011

(51) Int. Cl. G06Q 30/00

(52) U.S. Cl. 705/26.41

(57) ABSTRACT

A method for an e-commerce payment transaction to be processed by dynamically selecting at run-time, a third-party payment-processing gateway account, based on one or more rules and their attributes. An authorized system administrator configures and stores the rules and their attributes in a rules database for each third-party payment gateway. The system automatically selects the correct third-payment processing gateway account to be used for each by transaction by matching the pre-configured rules and their attributes against the properties of the payment transaction. The payment transaction is processed using the selected third-party payment gateway and is recorded in the e-commence platform payment processing database.

### BACKGROUND

An e-Commerce merchant account allows an online business (also known as an e-Business or e-Commerce business) to accept credit cards/debit cards, gift cards and other forms of payment cards online based on the Card Not Present (CNP) transaction principles, including mail order and telephone orders transactions. E-Commerce merchant accounts are acquired from either merchant banks or merchant service providers.

### Payment Gateways

A payment gateway is an e-commerce service that authorizes payments or transactions for e-businesses and online retailers. It is the equivalent of a physical POS (point-of-sale) terminal located in most retail outlets. A merchant account provider is typically a separate company from the payment gateway. Some merchant account providers have their own payment gateways but the majority of companies use third party payment gateways. The gateway usually has two components: a) the virtual terminal that can allow for a merchant to securely login and key in credit card numbers or b) have the website's shopping-cart connect to the gateway via an application programming interface (API) to allow for real time processing from the merchant's website.

The terms “transaction” and “purchase” may be used interchangeably and shall refer to any financial transaction initiated by the customer at a point of purchase, which could be a physical POS terminal or a non-physical POS terminal, such as an Internet webpage.

A payment processing gateway can be thought of as the connection between the e-Commerce merchant account affiliated website (online shop) and the merchant bank. One of the main functions of a payment processing gateway, besides communication, is encryption. Secure Internet transactions are performed using secure socket layer (SSL) encryption technology.

When a customer selects to purchase an item and they decide to pay by credit card, their web browser is told to open up a secure connection to the web site's Host's Secure server. The URL will change so that the “http:” changes to “https:” which indicates the server is secure. When a web browser is connected to a secure server, a small padlock will appear at the bottom right corner of the screen to indicate the secure connection meaning that all of the data being passed is encrypted for transmission. The secure web site host will upload the customer's credit card or check information along with all other order information, and assemble a transaction using the merchant's merchant account number and PIN and then send the transaction to the gateway's secure server. A payment gateway uses SSL 128-bit encoding technology to encrypt and decrypt all of the data being sent through it.

A secure payment gateway provides an encrypted connection between a web site's Secure Server host and a non-internet based processor, or Card Network, allowing for an “authorization” to be requested and received in real-time. Real-time processing means that when a web site's customer conducts an online purchase, the check or credit card information is conveyed to the processor at that exact time so that an authorization can be requested and received at that moment.

A typical transaction is represented in the flowchart of FIG. 6.

A customer elects to check out their purchases made on a shopping cart or order form on a merchant's web site at 601. The customer selects to pay by credit card at 602. The customer's browser brings up the secure payment form by connecting to the website host's secure server at 603. The customer enters his or her credit card information on the secure payment form and authorizes the transaction. All of the data is encrypted (SSL 128 bit) by the customer's web browser. The transaction information flows to the website host's secure server using SSL encryption at 604. The secure server connects to the merchant's processing bank by a secure payment gateway (a third party which provides the connection to the processing bank via a land line) at 606. The payment gateway decrypts some of the information (only for statistical usage, no credit card details are held) re-encrypt it and forwards it to the merchant's processing bank. The processing bank forwards the data to the credit card issuing bank for verification and authorization at 607. If approved, an authorization code is returned to the secured payment gateway from the processing bank. The entire process typically takes 2-3 seconds.

The authorization is encrypted by the payment gateway and transmitted in encrypted form to the web server of the merchant which triggers fulfillment of the order. The merchant's web server will then send the customer's browser a confirmation receipt. The amount due is moved from the card holder's bank to the merchant's processing bank. The merchant's processing bank moves the money to the merchant's local bank.

Due to the needs of companies to do e-commerce business in many different currencies and countries, companies tend to need regional payment gateways for processing e-commerce transactions. Companies may use one third-party payment gateway to process US Dollar in the United States while using a different one for Europe or Asia. For these reasons, companies have had to have separate e-commerce applications to handle different regions. To overcome this limitation companies create multiple applications to handle different regions and payment processing gateways. This increases the cost of doing business, introduces data/process management challenges, and provides inconsistent and unpleasant customer experience.

The dynamic multi-gateway system (DMGS) allows an e-commerce providing company to configure multiple third-party gateways and use them within the same application based on a set of configurable rules and their attributes. With this method companies can use a single application to process payments where multiple payment processing gateways need to be selected dynamically.

### Common Terms Used

Application programming interface (API): is a particular set of rules and specifications that software programs can follow to communicate with each other. It serves as an interface between different software programs and facilitates their interaction; similar to the way the user interface facilitates interaction between humans and computers.

Third-party payment gateway: is an e-commerce application service provider that authorizes payments for e-commerce transactions on the Internet. It is the equivalent of a physical point of sale terminal located in most retail outlets. Payment gateways protect credit card details by encrypting sensitive information, such as credit card numbers, to ensure that information is passed securely between the customer and the merchant and also between merchant and the payment processor.

Secure Sockets Layer SSL: is a protocol for transmitting private documents via the Internet. SSL uses a cryptographic system that uses two keys to encrypt data—a public key known to everyone and a private or secret key known only to the recipient of the message. By convention, URLs that require an SSL connection start with https: instead of http.

### SUMMARY OF THE INVENTION

According to one aspect of the invention, there is provided a method for dynamically selecting a third-party payment gateway from a plurality of third-party payment gateways. The method includes:

receiving, by a computer based system for selecting the third-party payment gateway from among a plurality of third-party payment gateways, payment criteria, wherein the payment criteria is transmitted by a customer to the computer based system;

querying, by the computer based system, a directory of third-party payment gateways in an attempt to locate a third-party payment gateway to process the transaction based at least in part upon the received payment criteria, wherein the querying is not performed by an acquiring bank; and

returning, by the computer based system, an identification of the located third-party payment gateway to process the transaction.

According to a second aspect of the invention, there is provided a computer based system including a computer network communicating with a memory. The memory communicates with a processor. The processor, when executing a computer program for dynamically selecting a third-party payment gateway from a plurality of third-party payment gateways, is configured to:

receive payment criteria, wherein the payment criteria is transmitted by a customer to the computer based system;

query a directory of third-party payment gateways in an attempt to locate a third-party payment gateway to process the transaction based at least in part upon the received payment criteria, wherein the querying is not performed by an acquiring bank; and

return an identification of the located third-party payment gateway to process the transaction.

According to a third aspect of the invention, there is provided a non-transitory computer-readable medium having stored thereon a plurality of instructions for selecting a third-party payment gateway, the plurality of instructions, when executed by a processor, are configured to cause the processor to perform operations comprising:

receiving payment criteria, wherein the payment criteria is transmitted by a customer to the computer based system;

querying a directory of third-party payment gateways in an attempt to locate a third-party payment gateway to process the transaction based at least in part upon the received payment criteria, wherein the querying is not performed by an acquiring bank; and

returning an identification of the located third-party payment gateway to process the transaction.

### BRIEF DESCRIPTION OF THE DRAWINGS

FIG. 1 illustrates an overview diagram of a dynamic multi-gateway system (DMGS) and method of the present invention.

FIG. 2 shows an example of the rules and attributes used in the DMGS system to determine the gateway to use for processing the payment transaction.

FIG. 3 shows the flow of the payment processing transaction in which a gateway is selected and the payment transaction request is sent to the third-party payment-processing gateway.

FIG. 4 illustrates a data model of the persistent backend of the DMGS

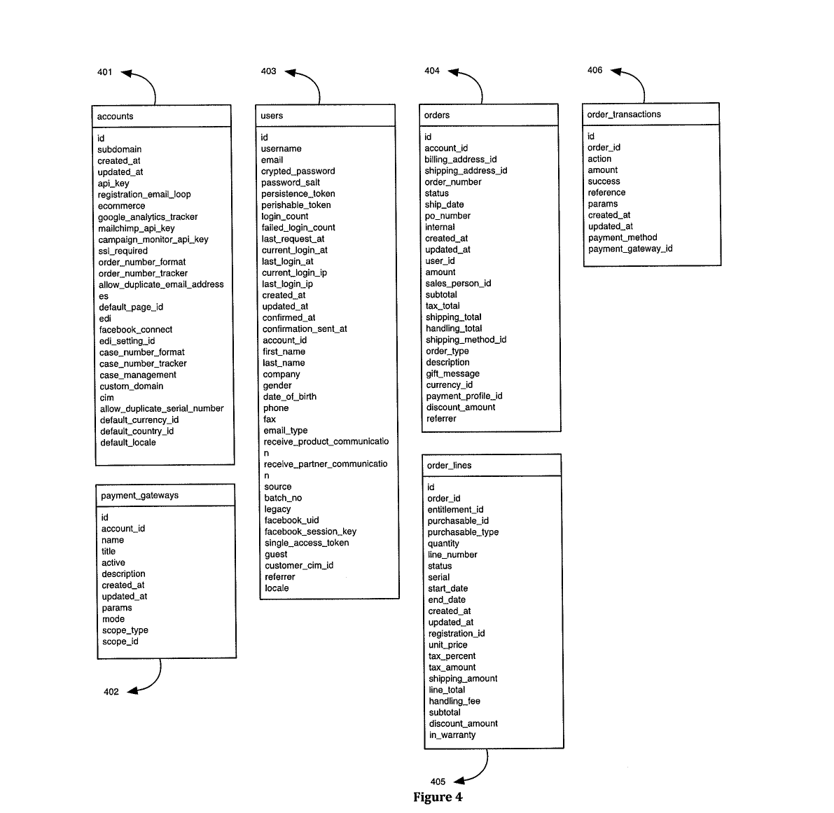

FIG. 5 illustrates a detailed data model of the rules and attributes of the persistent classes stored in a rules database that function in the backend of the dynamic multi-gateway system of the embodiments of the invention.

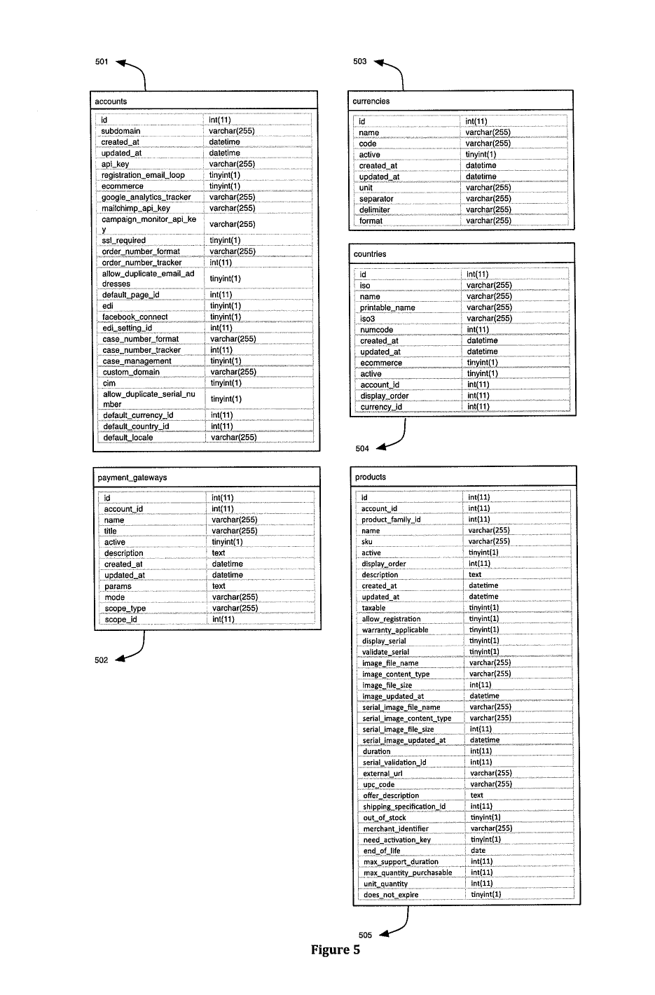

FIG. 6 illustrates a flow chart of a typical e-commerce transaction.

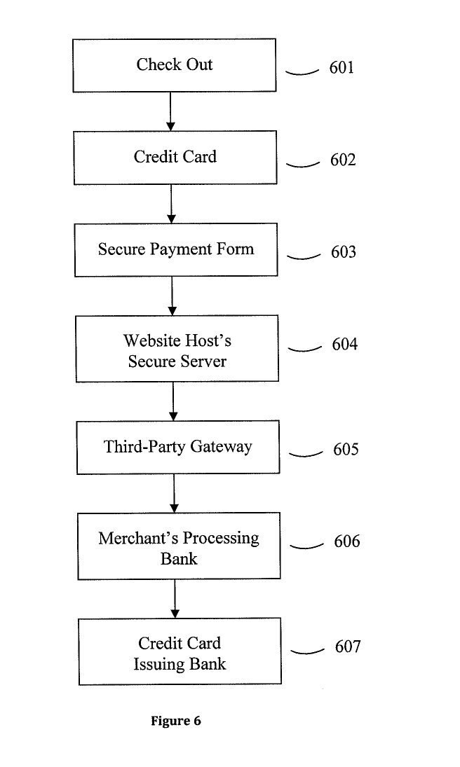

FIG. 7 illustrates a flow chart of the third-party payment gateway selection process.

### DETAILED DESCRIPTION OF THE PREFERRED EMBODIMENTS OF THE INVENTION

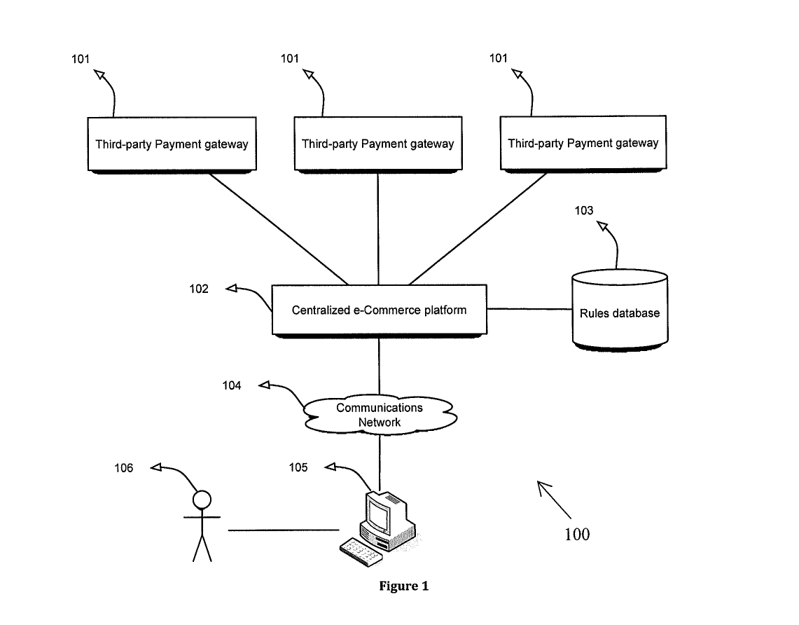

FIG. 1 illustrates an overview diagram of an embodiment of a dynamic multi-gateway system (DMGS) and method of the present invention.

Included in the system are third-party payment gateways 101, a centralized e-Commerce platform 102, a rules database 103, a communications network 104, and customers 106 coupled with the system through computer systems 105 (of which only one is shown to simplify the description).

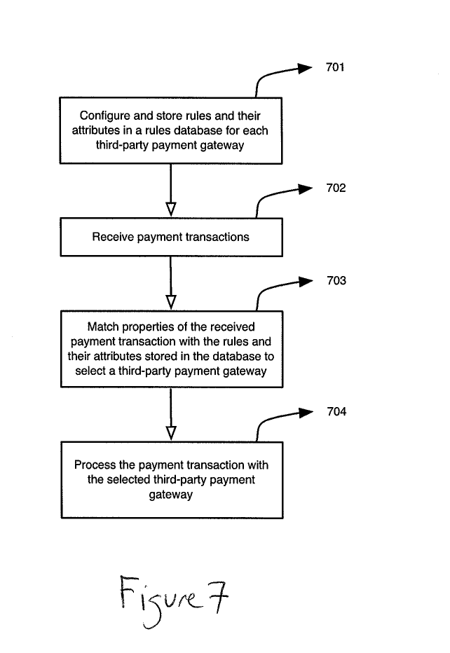

FIG. 7 illustrates a flow chart of the third-party payment gateway selection process. To enable the system 100, at some point 701, a system administrator configures and stores rules ad their attributes in a Rules database for each third-party payment gateway. When the system 100 is being used, a payment transaction 702 is received by the centralized ecommerce platform 102. The centralized ecommerce platform matches properties of the received transaction with the rules and their attributes stored in the Rules database 103 to select an appropriate third-party payment gateway to process that transaction at 703. Then, at 704 the payment transaction is processed using the selected third-party payment gateway.

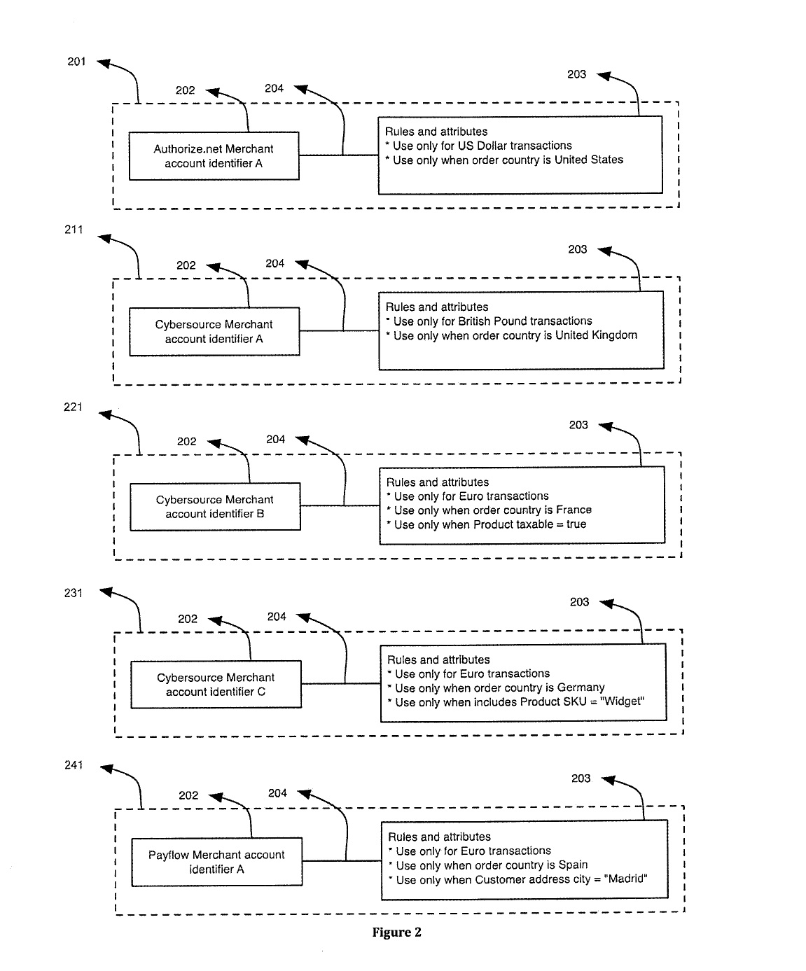

FIG. 2 shows an example of the rules and attributes used in the DMGS system to determine the gateway to use in processing the payment transaction. For example, illustrated at box 201 the rules and attributes indicate that if the order country of the transaction is the U.S. and the payment is in U.S. dollars, then the gateway “Authorize.net Merchant Account Identifier A” should be used. If, as shown in box 211, the rules and attributes indicate that if the order country for the transaction is the U.K. and payment is to be in British pounds, then gateway “Cybersource Merchant account identifier A” should be used. If, as shown in box 221, the rules and attributes indicate that if the order country is France and payment is to be in Euros and the product is subject to tax, then gateway “Cybersource Merchant account identifier B” should be used. If, as shown in box 231, the rules and attributes indicate that if the order country is Germany and payment is to be in Euros and the product SKU indicates it is a “widget,” then gateway “Cybersource Merchant account identifier C” should be used. If, as shown on box 241, the rules and attributes indicate that the origin country is Spain and payment is to be in Euros and the customer's address city is Spain, then gateway “Payflow Merchant account identifier A” should be used.

Thus, the gateway can be selected based on a number of parameters as described above including whether a product or service is being purchased, country of origin, currency, taxes related to payment of an item purchased, and/or merchant or merchants of record on the transaction.

Also, it is possible to take consolidated orders for products and/or services from different vendors or merchants of record and send to different gateways along with appropriate information from the order.

### System Requirements

The DMGS 100 strictly uses SSL technology to securely transmit payment information to the dynamically selected third-party payment processing gateway. The payment processing back-end consists of an application executing in a web application server interacting with a backend database that persists the payment gateway connectivity information, APIs that use web services and a file system. Payment data is never stored in the database.

### Data Communication

All communications between the DMGS, third-party payment processing gateways and ancillary systems are conducted securely over the Internet using secure, encrypted SSL technology. Data is exchanged using XML over web services.

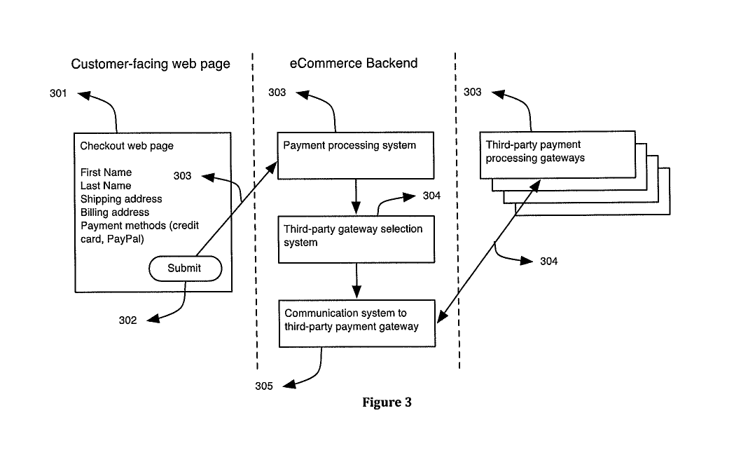

FIG. 3 shows the flow of the payment processing transaction in which a gateway selected. When a customer places the order 302, a request is sent using encrypted SSL to the payment processing system 303 in the e-commerce platform. The request is validated and all order attributes are calculated, including taxes, subtotals and totals.

The third-party gateway selection 304 is invoked to identify the best gateway to use for this customer transaction. The order attributes are compared to the DMGS rules database 103 attributes to evaluate as per the configuration FIG. 2. The configuration is stored in the payment_gateways 402 502 persistence table in the polymorphic columns scope_type and scope_id.

Scope_type is an identifier for the type of evaluation needed. DMGS can support any type of implemented scope including but not restricted to values ‘Currency’, ‘Country’ 503, ‘Product’ 504, ‘ProductFamily’, ‘User’ 403, etc. scope_id contains the record id of the scoped (using scope_type) object. The scoped object identified in scope_type is instantiated and searched using the scope_id. If a matching result is found, the payment gateway configuration record 402 502 is used to process the transaction. If more than one matching result is found, the first matching payment gateway configuration record is used to process the transaction.

If a possible payment gateway is not found, the order is declined and not processed.

What is claimed is:

1. A method for dynamically selecting a third-party payment gateway from a plurality of third-party payment gateways comprising:
receiving, by a computer based system for selecting the third-party payment gateway from among a plurality of third-party payment gateways, payment criteria, wherein the payment criteria is transmitted by a customer to the computer based system;
querying, by the computer based system, a directory of third-party payment gateways in an attempt to locate a third-party payment gateway to process the transaction based at least in part upon the received payment criteria, wherein the querying is not performed by an acquiring bank; and
returning, by the computer based system, an identification of the located third-party payment gateway to process the transaction.

2. The method of claim 1, further comprising interacting with the identified third-party payment gateway to process the transaction.

3. The method of claim 2, wherein the querying includes selecting the third-party payment system based upon attributes of the transaction.

4. The method of claim 2, wherein the querying includes selecting the third-party payment gateway based upon one or more of the following: a payment instrument selected by the customer, a payment currency; taxes related to payment of an item purchased, country item ordered from, whether item is a product or service, or merchant of record.

5. A computer based system, comprising:
a computer network communicating with a memory;
the memory communicating with a processor; and
the processor, when executing a computer program for dynamically selecting a third-party payment gateway from a plurality of third-party payment gateways, is configured to:
receive payment criteria, wherein the payment criteria is transmitted by a customer to the computer based system;
query a directory of third-party payment gateways in an attempt to locate a third-party payment gateway to process the transaction based at least in part upon the received payment criteria, wherein the querying is not performed by an acquiring bank; and
return an identification of the located third-party payment gateway to process the transaction.

6. The computer based system of claim 5, further configured to interact with the located third-party payment gateway to process the transaction according to payment criteria.

7. The computer based system of claim 6, wherein the query includes selecting the third-party payment gateway based upon attributes of the transaction.

8. The computer based system of claim 6, wherein the query includes selecting the third-party payment gateway based upon one or more of the following: a payment instrument selected by the customer, a payment currency; taxes related to payment of an item purchased, country item ordered from, whether item is a product or service, or merchant of record.

9. A non-transitory computer-readable medium having stored thereon a plurality of instructions for selecting a third-party payment gateway, the plurality of instructions, when executed by a processor, are configured to cause the processor to perform operations comprising:
receiving payment criteria, wherein the payment criteria is transmitted by a customer to the computer based system;
querying a directory of third-party payment gateways in an attempt to locate a third-party payment gateway to process the transaction based at least in part upon the received payment criteria, wherein the querying is not performed by an acquiring bank; and
returning an identification of the located third-party payment gateway to process the transaction.
